(19) United States
(12) Patent Application Publication
(10) Pub. No.: US 2010/0305724 A1
(43) Pub. Date: Dec. 2, 2010

(54) VEHICLE COMPETITION IMPLEMENTATION SYSTEM

(76) Inventors: Robert Eric Fry, Auckland (NZ); Peter Roland Newport, Auckland (NZ)

Correspondence Address: ICE MILLER LLP, ONE AMERICAN SQUARE, SUITE 3100, INDIANAPOLIS, IN, 46282-0200, US

(21) Appl. No.: 12/746,697

(22) PCT Filed: Dec. 17, 2008
(86) PCT No.: PCT/NZ08/00336

§ 371 Date: Jul. 8, 2010

(30) Foreign Application Priority Data
Dec. 19, 2007 (NZ) 561260
Oct. 2, 2008 (NZ) 571726

(51) Int. Cl. G06F 19/00

(52) U.S. Cl. 700/92

(57) ABSTRACT

A set of computer executable instructions configured to calculate penalties for a vehicle pilot navigating a competition course which incorporates at least one virtual obstacle, said set of instructions being configured to execute the steps of: a) receiving a vehicle location identifier associated with the present position of the pilots vehicle, and b) comparing the vehicle location identifier with a collision region associated with at least one virtual obstacle of the competition course, and c) assigning at least one penalty to the pilot of the vehicle if the vehicle's location intercepts with the collision region of an obstacle, and d) repeating steps a) through c) as the pilot navigates the competition course and the position of the vehicle changes.

### TECHNICAL FIELD

This invention relates to a vehicle competition implementation system.

The invention may provide a competition course defined by a plurality of virtual obstacles to be navigated by one or more vehicles.

The present invention also encompasses a method, system and/or apparatus for tracking the progress of a vehicle over such a competition course, and calculating and assigning competition penalties to a vehicle's pilot depending on their success at navigating the virtual obstacles presented.

### BACKGROUND ART

Vehicle based competitions are popular forms of sporting entertainment. In particular, cars and other types of road vehicles race against one another as the vehicles navigate a static road course layout. Off road or four wheel drive vehicles can also compete against one another, with competition points being awarded or deducted from drivers depending on their success at navigating terrain based obstacles. Air racing is also a relatively new vehicle competition format where small aircraft pilots attempt to navigate a race course defined by a number of large obstacles in the shortest possible time.

These vehicle based competitions, and races in particular, involve a high degree of risk to the vehicle drivers and/or pilots, particularly when obstacles are to be navigated at high speeds. This is certainly the case with air racing where a collision with an obstacle could result in an aircraft crashing and endangering the pilots, as well as nearby spectators and property.

Generally, the obstacles used to define such competition courses are static in character and also in their position or location in the course defined. These obstacles serve to provide crash barriers or to delineate the boundaries of the course to be navigated by a vehicle. In practice a large amount of time and effort is required to lay out such competition courses, and in the case of air racing the assembly and subsequent disassembly of these obstacles can be a costly exercise.

In the case of collisions in race competitions, the speed of the vehicle will generally result in vehicle damage and the vehicle therefore being unable to complete the course.

It would be of advantage to have an improved vehicle competition implementation system which addressed any or all of the above problems. In particular, a system, method or apparatus which could allow virtual obstacles to be deployed to form or define a competition course would be of advantage. Furthermore, it would be of advantage to have a system, method or apparatus which could track the progress of a vehicle over such a course of virtual obstacles and automatically assign penalties to a vehicle pilot if an obstacle collision occurs. A system, method or apparatus which could also allow for the deployment of virtual obstacles with dynamic characteristics would also be of advantage over the prior art.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

A set of computer executable instructions configured to calculate penalties for a vehicle pilot navigating a competition course which incorporates at least one virtual obstacle, said set of instructions being configured to the execute steps of;
a) receiving a vehicle location identifier associated with the present position of the pilot's vehicle, and
b) comparing the vehicle location identifier with a collision region associated with at least one virtual obstacle of the competition course, and
c) assigning at least one penalty to the pilot of the vehicle if the vehicle's location intersects with a collision region of an obstacle, and
d) repeating steps a) through c) as the pilot navigates the competition course and the position of the vehicle changes.

According to a further aspect of the present invention there is provided a method of calculating penalties for a vehicle pilot navigating a competition course deployed substantially as described above, characterised by the steps of;
a) receiving a vehicle location identifier associated with the present position of the pilot's vehicle, and
b) comparing the vehicle location identifier with a collision region associated with at least one virtual obstacle of the competition course, and
c) assigning at least one penalty to the pilot of the vehicle if the vehicle's location intersects with a collision region of an obstacle, and
d) repeating steps a) through c) as the pilot navigates the competition course and the position of the vehicle changes.

The term vehicle should be interpreted as any moving object and can include humans such as runners and swimmers as well as mechanical devices.

The present invention is adapted to provide a vehicle competition implementation system. Those skilled in the art should appreciate that the present invention incorporates a number of aspects from a method of implementing a vehicle competition, through to hardware components or apparatus employed to execute the method of the invention.

Reference in general throughout this specification will however be made to the present invention being provided by a method of competition implementation, but those skilled in the art should obviously appreciate that appropriately configured hardware components and/or software instructions are also within the scope of same.

The present invention can be used to deploy a competition course to be navigated by a plurality of vehicles. This competition course can define a fixed route or set of paths which a vehicle may navigate to successfully complete the competition course.

It is envisaged that in preferred embodiments that the competition course will be altered on an ongoing basis dependent on pilot feedback, atmospheric conditions and visual impressiveness of the aerobatic spectacle. It is important that the managing of any amendments to the competition course shows that safety is not compromised at any point. Therefore, it is envisaged that the delivery of updated maps will be made to the pilots due to fly, or flying the competition course as well as any ground animation team.

In some embodiments the update may be achieved through a wireless upload, although given the large amount of data, this may be via a physical download into a unit mounted on the planes.

A preferred feature of the present invention is that any changes to the display is made in real time—given the quick reactions required of the pilots to adjust to the competition course with respect to their orientation and positioning thereto. Therefore, it is critical that the data management algorithms are configured to be as efficient and accurate as possible. To this end, in preferred embodiments, fixed point mathematics is used in contrast to the more traditional floating point mathematics. Fixed point mathematics run approximately three times faster than floating point on the preferred processor which is a 667 MHz cortex-A8 ARM core.

Obviously, this choice of processor should not be seen as limiting. Ideally the ARM core would be used in combination with an open GL-ES 3D acceleration engine, the combination being similar to the Texas instruments OMAP3530 platform. Other platforms are of course envisaged.

A basic indicator system assist the pilot flying the course correctly could use arrows (or some other indicator) to direct the pilot to the current object and the next object they should be flying through.

For example, different coloured pointers can be used which change shape to indicate proximity to/and relative position to single/multiple obstacles.

Preferably, pilot needs are met by having full flight paths overlaid into the display. Part of the reason for an indicator system is that in a basic form of the present invention the pilots are only to see objects directly in front of the plane. Some embodiments of the present invention use a system that takes into account the head orientation of the pilot and this is discussed later on in the patent specification.

The competition course of the present invention can be defined with the assistance of a number of virtual obstacles displayed concurrently to a pilot of a vehicle as discussed in further detail below.

In a preferred embodiment a vehicle used to navigate the competition course may be an aircraft. Air racing competitions are known which combine aerobatics with racing disciplines. The present invention facilitates the implementation or deployment of an air racing competition course in such applications. Furthermore, reference throughout this specification will also be made to the operator of the vehicle involved being a pilot. Those skilled in the art should appreciate that the use of such terminology throughout this specification should in no way exclude riders, drivers or any other types of operators of different forms of vehicles.

As discussed above, in alternative embodiments the present invention may be employed to provide competition courses for vehicles other than aircraft. Those skilled in the art should appreciate that competition courses may be provided for race cars, racing watercraft, motorcycles or any other vehicle which can be raced, which can be used in a competition to avoid obstacles, or to actively seek to collide with obstacles. Reference throughout this specification to the use of the present invention in air racing applications in isolation should in no way be seen as limiting.

In yet other alternative embodiments the present invention may be employed to implement a competition course which need not be navigated by a powered or motorised vehicle. For example, in other embodiments, competition courses provided in conjunction with the present invention may be navigated by use of roller blades, bicycles, skis, snowboards, water skis, or any other types of transport apparatus which need not necessarily incorporate a power source or motor. Athletes such as runners and swimmers which perform unassisted may also be included.

Preferably the competition course deployed may be used by a plurality of aircraft which may navigate the course one after the other, or alternatively may race in a head to head configuration on two or more identical, similar or handicap adjusted competition courses deployed adjacent to one another.

It should be appreciated that for the present invention to work well, real time navigation is needed and that requires real time position and orientation solutions for the aircraft.

The inventor has identified a number of conditions which can apply to a preferred embodiment as below.
a) Must be continuous regardless of whether the aircraft was inverted or undergoing high acceleration (up to 10-11 g) and high rotation (over 360 degrees per second).
b) Must be generated in real-time.
c) Must have low latency.
d) Must be a high update rate (greater than 10 Hz, typically 20-30 Hz, possibly up to 50-60 Hz).
e) Must be high accuracy, particularly as the position and orientation of the aircraft is used to reconstruct the positions of the virtual obstacles for the pilot.
f) Must be smooth so that the motion of the computer generated aircraft looks realistic.
g) Must be relatively lightweight (a few kilograms).
h) Must be relatively low power (able to be supported either by the aircraft's existing power supply or by a small separate battery)
i) Must be affordable.
j) Must be either available, or constructed from, commercially available components.
k) Must be robust under high dynamics.
l) Must generate a position solution that has better accuracy than 10 m, preferably 1 m or better.
m) Must generate an orientation solution that is sufficient to accurately reconstruct the virtual course. Absolute accuracy in terms of degrees was not specified but was expected to be better than 1 degree in roll, pitch and heading and is potentially likely to become higher as the system is refined.
n) The attitude of the aircraft must be the true attitude of the aircraft relative to a defined reference frame such as WGS84.
o) The aircraft platform may experience high vibration from the engine.

To address these requirements it was clear that GPS alone is unable to provide the required information. Firstly GPS is unable to generate an attitude solution, unless a multiple antenna GPS system is used which would require good satellite availability (i.e. would unlikely to work satisfactorily in an environment where the aircraft is likely to be inverted).

To generate an attitude solution it was clear that inertial sensors would have to be used. The challenges faced were primarily as a result of the aircraft undergoing high dynamic manoeuvres (acceleration of up to 10-11 g and rotations>360 degrees per second). Furthermore the aircraft can fly inverted which obscures the GPS antenna and makes continuous tracking of GPS signals more difficult.

Two main technologies are currently available that are potential solutions: Attitude and Heading Reference Systems (AHRS) and integrated GPS/INS (Inertial Navigation System). AHRS sensors use a combination of gyros, accelerometers and magnetometers to construct a 3 dimensional orientation solution. These systems essentially work by deriving heading from the magnetometers and roll and pitch from the accelerometers. Measurements from the gyros are used to smooth the attitude. In situations with potentially high vibration and high acceleration, these AHRS systems were not expected to work effectively using most off-the-shelf systems.

Instead it was proposed that an integrated GPS/INS solution was used. An INS is an Inertial Navigation System that comprises of an Inertial Measurement Unit (IMU), GPS receiver and microprocessor that runs a filter to optimally combine the measurements from each system. GPS/INS has the following advantages:
Provides continuous position and orientation regardless of GPS reception (GPS reception is affected by the high acceleration of the aircraft and the orientation of the GPS antenna).
The INS can bridge brief periods of obscured GPS (such as when the aircraft is inverted).
The accuracy of the position and attitude solution is typically very accurate with the accuracy dependent on the availability of GPS, the dynamics of the aircraft, the length of time of the system has been operating and the quality of the inertial sensors used.
Differential GPS can be used to improve performance by removing unmodelled atmospheric and GPS system biases from the GPS solution.
Commercial systems are available to meet the requirements.

Those skilled in the art should appreciate that the present invention provides a significant degree of flexibility in terms of how such competitions can possibly be managed.

As discussed above, the competition course to be navigated includes a number of virtual obstacles which at the very least can assist in defining a route, or several possible routes which can be navigated to complete the course. In a further preferred embodiment the virtual obstacles presented are to be avoided by aircraft pilots, and hence serve to delineate or define the boundary areas of a course. In such embodiments the virtual obstacles presented should be avoided where possible by aircraft pilots to avoid the assignment of penalties to a pilot who collides or otherwise interacts with an obstacle. It should be appreciated that obstacles can also be dynamic (e.g. rotate)—so a pilot has to time the approach to negotiate the object correctly.

Reference in general throughout this specification will also be made to the present invention deploying virtual obstacles which are to be avoided by a pilot navigating the competition course. However, those skilled in the art should appreciate that pilots may be required to complete other forms of interactions with virtual obstacles to successfully complete a competition course.

For example, in one alternative embodiment a pilot may be asked to actively seek collisions with virtual obstacles. In such instances these virtual obstacles may define a set of paths or tracks, or may provide a number of discrete objects or obstacles which a pilot is to contact during the navigation of the course. In addition, in other embodiments a competition course may also at least partially be defined by traditional physical obstacles if available or if appropriate. For example, in some instances such physical obstacles may be formed by crash barriers for racing cars or motorcycles, with virtual obstacles used to present additional challenges to be navigated by drivers or riders.

In yet other embodiments virtual obstacles may provide bonus target objects which the vehicle operator can aim to collide with to provide a performance or tactical advantage—potentially in reverse of the processes discussed below with respect to penalties.

As an example, the bonus target object could be used to shorten the course for a pilot. It is envisaged however that this bonus target object may be positioned outside of the normal course. Therefore, there is a risk calculation that the pilot will have to make as to whether it is better to divert from the existing course and attempt to gain a bonus that will'reduce the overall length of the course, or whether continuing on the existing course would be less risky.

It should be appreciated however that whether a collision incurs a penalty or a bonus, it is most likely that the penalty/bonus will be in the form of altering the length of the course. This ability to have a dynamic course provides a very clear indication to participants and viewers as to who is the winner of a particular competition. This is because that instead of having a point system, the aircraft that finishes the course first will be the winner. Such an immediate and visually apparent result gives instant gratification to the viewers and participants alike.

To deploy the competition course, virtual obstacles are overlaid on a pilot's view of the competition course. For example, a pilot may employ a heads up display (HUD) which can overlay a display of virtual objects on a transparent display screen over a pilot's actual view of the real world region on which the competition course is to be deployed. The term HUD also includes a headset or helmet mounted display—which either projects images into a display or directly into the eyes of the pilot.

For example, heads up display technology such as that disclosed in PCT Patent Publication No. WO 2005/121707 may be employed to present such virtual obstacles. A heads up display, employed by the invention may also utilise position tracking for the aircraft or vehicle's position in conjunction with a pilot helmet orientation determination system. For example, in some embodiments the present may employ the flight tracker technology of InterSense as described by publications posted at www.InterSense.com. The use of HUD technology allows the present invention to simulate the presence of virtual obstacles at specified locations assigned to each obstacle in the real world region in which the course is to be deployed. Although virtual obstacles are not physically present in this real world region, their presence can be simulated for a pilot using such HUD technology.

In one embodiment of the present invention, the head set uses a head orientation system with a matrix of reflectors on the back of the pilot's helmet. These reflectors could reflect light (most likely infrared, although visible may suffice) to a sensor within the plane. The sensors can then supply data to a micro-processor which will calculate head orientation relative to the aircraft orientation.

In other embodiments there may be provided emitters instead of reflectors on the pilots helmet. For example these may be of various types including acoustic, visible light and other electromagnetic emitters. Corresponding sensors will likely to be used.

The inclusion of reflectors (which could be adhesive dots—although this should not be seen as limiting) can provide an offset between the actual positions of the pilot's head in a relative position to the virtual objects in the onboard computer. This enables the pilot to always see the objects in the correct position in time and space. As the pilot is strapped into the plane, the precise difference between the aircraft orientation and the pilot's direction of sight can be calculated to provide the accuracy required for the pilots to perceive the virtual objects in a real landscape.

In other embodiments, the pilots helmet may have a coating which is patterned in such a way that sensors can detect the change in position of the patterns when the pilot moves its head.

In yet another embodiment, an inertial sensor may track the pilot's head orientation relative to the aircraft.

In one embodiment of the present invention, the headset (or HUD) that the pilot employs may illustrate the virtual course in colour. This can provide additional information to the pilot than that possible with a monochromatic display.

It is possible that the course may have various options associated with different colours. For example, the pilot may have obstacles identified in one colour for the pilot to follow, and may also illustrate the obstacles in another colour for another pilot to follow.

Further, the use of colour can be used to provide greater definition in the display, making it easier for the pilot to not only identify an obstacle but also to better judge its orientation and positioning against the background skyscape/landscape.

In some embodiments of the present invention, there may be provided a headset (or HUD) which is stereoscopic. That is, different information is fed to each eye of the pilot. If this information is stereoscopic, then the pilot has greater depth perception as to the positioning of the virtual obstacles on the display.

In some embodiments the head set may be of a retinal display type which can project images directly onto the retina of the pilot. This could be monocular or stereoscopic.

A pilot's headset or HUD can also be employed to display additional information to a pilot other than just the virtual obstacles discussed above. For example, if a pilot strays from the general vicinity of the competition course, the HUD may display guidance or navigation indicators to lead the pilot back to the competition course. In yet other embodiments this HUD technology may also be employed to provide safety warnings to pilots in the event that there is a danger of the pilot colliding with another aircraft or the terrain. These safety warnings may take the form of visual elements displayed to a pilot and/or audio warning tones.

In addition to warnings as discussed above, the headset or HUD can also provide the pilot with audio or visual prompts and messages. For example, the race coordinator may need to announce the restart of a race which can be transmitted to them.

In some embodiments of the present invention, data relating to the other aircraft may also be sent to the HUD of a pilot. This data may be the actual positioning of the other aircraft in which case this will be very useful not only as a safety warning, but also to provide competitive data. For example, if you knew a competing pilot was in a certain position, this may influence the course that you take, for example whether to try out for a bonus target object.

In some embodiments, the presence of a virtual race aircraft (or multiple virtual aircraft) may also be displayed to the pilot—possibly in greyed out or “ghost” format.

In some embodiments of the present invention, the virtual course may actually be removed from the HUD under certain circumstances. These circumstances could be when software associated with the present invention considers that the pilot is in danger of colliding with either another plane or the landscape.

For example, it is envisaged that pilots will be very focussed on competing and looking for the virtual obstacles. There is a possibility that the pilot may not be as focused upon the real life obstacles as an a consequence. Therefore, dropping the virtual obstacles from the pilot display at potential times of danger can alert the pilot to a potentially dangerous situation, and enable the pilot to better comprehend the real life landscape without the super imposed obstacles.

In some embodiments of the present invention, there may be provided spotters on the ground that can monitor the aircraft for safety. For example, the spotters could be in the form of people, cameras or some automated sensored system.

In a further preferred embodiment the HUD display technology may also employ audio tones in addition to or instead of visual information displayed to a pilot. Audio tones may be provided in such embodiments to indicate proximity to nearby virtual obstacles.

In yet other embodiments a pilot's HUD may be employed to display competition penalties incurred by the pilot's performance, calculated as discussed further below.

In a preferred embodiment each virtual object may have assigned to it a location identifier. Preferably the present invention may also employ location identifiers associated with vehicles navigating a course. The use of the same location co-ordinate system can be used to easily compare the actual or present position of the pilot's vehicle with an associated location assigned to each obstacle integrated into the competition course.

The virtual obstacles employed in conjunction with the present invention may be defined by two dimensional or three dimensional graphical object representations of any required shape or form. Those skilled in the art should appreciate that the actual objects represented by such virtual obstacles can be tailored to the particular competition in which the present invention is employed, in addition to a targeted possible audience for the competition.

For example, in some embodiments virtual obstacles may be employed to present any one or combination of the following elements: start lines or windows, turning points, general areas of obstacles to be avoided, loops or circles for an aircraft to pass, animated objects for an aircraft to pass through or avoid, virtual low or high level limiting lines or planes, timed objects which change configuration over time, finish lines or windows and/or indicators which display range or trajectory information.

In some embodiments the virtual obstacles displayed may be static in nature and also in the location on the course which the obstacle is deployed. In such embodiments these static virtual obstacles may simulate existing prior art real physical objects currently used to define competition courses.

However, in other embodiments the virtual obstacles may have a dynamic nature, potentially both in the location assigned to the obstacle on the course in addition to the form, shape or appearance of the graphical representation of the obstacle. For example, in some alternative embodiments the location of an obstacle may change over time to introduce a further degree of randomness or excitement to the competition. In other embodiments an obstacle may have a dynamic configuration (eg, a windmill with rotating blades), where a pilot needs to avoid the moving components of the obstacle. In yet in other embodiments the dynamic nature of such obstacles may be triggered by real world events, such as one pilot in a head to head race reaching a way point ahead of another pilot. These events may potentially trigger a reconfiguration of one or more virtual obstacles of the course and/or potentially the route or routing defined for the course.

It should be appreciated that the obstacles seen by the pilot do not have to be the same images as seen by the audience, but the position and the dimension of the area to be negotiated needs to be similar.

It should also be appreciated that different obstacles and logos can be used in real time for different audiences. For example, the present invention may be broadcast to different territories with different advertising rules.

It is envisaged that in some embodiments of the present invention, there may be provided a filter system which provides for selected viewing for the pilots and audience to see.

There may be a different filter system between onboard and ground for example.

It should be appreciated that the present invention can be extended to more than just real life pilots, but also virtual pilots such as those competing in a video game or online gaming. This particular aspect of the present invention is discussed later in the specification, however it should be appreciated that as a consequence of this embodiment, pilots my see virtual planes being piloted by others on the ground.

The pilots may see just the virtual planes and obstacles present in their immediate field of view. However, it could be that the audience would see other information as well such as performance, location and specification chosen from a menu. It is envisaged that for example television broadcasters could use this filter system to edit the broadcast coverage. Likewise, online “players” could use a similar system.

Real pilots could see filtered virtual planes as well—perhaps by number, location of virtual player (country/town etc), lead position and sponsor. Further, pilots could see other real pilots' position on-screen along with useful information such as winning/losing margin in various formats eg: graphical or numerical. This aspect can also include the collision avoidance system.

Penalties to be calculated and assigned to a particular pilot may vary depending on the form of competition in which the present invention is employed. For example, in some instances penalty points may be assigned or deducted from a pilot's competition points, or penalty time may be added to a pilot's race time for the course.

In preferred embodiments penalties may take the form of a dynamic reconfiguration of the competition course—potentially extending or increasing the distance which a pilot has to travel prior to completing the course, or adding additional obstacles to be navigated. In such cases a finish line object may be moved further away from the current position of the aircraft with the extension of distance involved being proportional to the extent of overlap or collision with the obstacle.

This provides viewers and the pilot with a very simple means by which the winner of the race can be determined. That is, the first pilot to finish its course wins. There is no need to calculate points afterwards, instead there is just a simple visual cue provided.

In a further preferred embodiment penalties to be assigned to a pilot may vary in their detrimental effect on a pilot's performance based on the extent of the offence which triggered the assignment of the penalty. For example, in some instances penalties may be assigned to a pilot if the pilot collides with a virtual object. If a glancing collision occurs the penalty assigned may have a lesser effect than if a pilot flies directly into the obstacle.

The relative damage could be calculated by the degree of conflict in space coordinates. Therefore, penalties assigned could be proportionate to the degree of conflict with the objects.

Preferably each and every virtual obstacle displayed may have an associated collision region defined. These collision regions may specify a two dimensional or preferably a three dimensional space which, if entered by any portion of the aircraft, will register that a collision with the obstacle has occurred. For example, in some embodiments a virtual obstacle may be defined by a static three dimensional shape or volume. The collision region of this volume would therefore be the same as the volume occupied by the three dimensional shape or form of the obstacle.

The present invention may employ the vehicle's location identifier and compare same with the collision regions of virtual obstacles making up the course to determine whether a penalty should be applied to the pilot involved. If the vehicle's location identifier indicates that at least a portion of the vehicle has entered an obstacle's collision region, then a penalty can be calculated and assigned to the vehicle pilot.

Those skilled in the art should appreciate that the size, shape or dimensions of a pilot's vehicle can also be modelled in some instances to provide a collision region for a vehicle defined relative to the vehicle's location identifier or GPS co-ordinates. This location centred model can be used to assess how much of the vehicle has intersected with the collision region of an obstacle. For example, in some embodiments, the GPS position of an aircraft may be defined as a centre point or centre of gravity from which the wingspan or lateral extent of the aircraft can be measured. A similar approach can also be taken with respect to the length and height of the aircraft from this defined centre point. However, in other embodiments the shape or form of a vehicle may be approximated by a standard offset radius or distance from the current location defined for the vehicle.

This penalty assignment determination process may in some instances be completed periodically with respect to all obstacles of a course or alternatively may only be completed with respect to obstacles near to the current location defined for the vehicle involved. Those skilled in the art should appreciate that a degree of flexibility is available in the ultimate implementation of this process of the invention.

Those skilled in the art should appreciate that the hardware or apparatus employed to implement the present invention may be arranged in a number of different architectures.

For example, in some instances a local system may be deployed in or within a vehicle navigating the competition course to obtain vehicle location identifiers, and to compare these with a local software map of virtual obstacles and their real world location values.

In other embodiments real time high speed data links may be provided between a vehicle and a central base station which performs all of the calculation work required on receipt of GPS data transmitted from the vehicle. Such a base station may in turn transmit to a vehicle graphics data to be displayed to the pilot or operator of the vehicle.

In a preferred embodiment the present invention may also provide a competition display system for spectators. This system may be employed to apply the same view of virtual obstacles seen by pilots to video footage delivered to spectators via television broadcasts or internet video delivery protocols.

The imagery supplied to spectators can be obtained from a variety of sources.

For example, helicopters and other camera platforms may be able to see all planes. Possibly, virtual plane footage could be fed into those platforms for shot framing purposes, as well as logistics, such as showing how to get to the right place on the course.

Geo referenced helicopter cameras or perhaps camera systems mounted on unmanned aerial vehicles could film a race using gyro stabilisation and inertial measuring references. This can enable considerable degree of flexibility in terms of degrees of freedom in showing the images of the race. For example, an aerial camera can pan, tilt and zoom in the real world with the virtual objects likewise changing size, texture, perspective and shadow to match.

The use of computer processing power and precise positioning systems means it is now possible to combine the real and virtual images in real time. By combining camera parameters such as the exact position of the camera head and exact state of the lens (focal length, lens characteristic, degree of pan, tilt and zoom) with the virtual object—the object can be made to appear as part of the real world. The subject can also be integrated into a dynamic camera shot of the real world.

This method involves first creating a virtual model of the relevant real world scene—and inserting the virtual object. The object can be either a ‘wireframe” model of the object—or a full resolution object with texture, shadows etc.

A real camera can then enter the real world scene—and the output from the camera can be combined with the virtual model—combining the virtual model with the real world imagery.

Different TV image layers can be used to create the correct masking of virtual objects—so that real vehicles pass in front of the rear sections of a 3D virtual object and appear to be behind the front sections of a 3D virtual object. The layering can be rendered in real time—and can use a dedicated computer for each camera (so as to achieve the required real time processing speed). Multiple layers may be required to achieve a totally “realistic” effect: Different technologies can be used to achieve this layering effect—but include chroma-keying, luminescent keying and other established methods for establishing different layers, “cut outs” or mattes within a TV image.

In the case of a moving camera (for instance mounted on a helicopter) an inertial and GPS positioning platform can be mounted in a central position on the aircraft—and carry out two simultaneous functions:
1. Use precise positioning data to remove vibration and unwanted movement from the camera head.
2. Provide precise position and lens state data for the camera head—using an offset—or inertial sensors mounted on or near the camera head.

This provides a stabilised camera image—which can be “geo-referenced” —and used to insert a virtual object in real time.

An onboard computer can store the virtual objects—to allow the camera to interact (by computer control or a human operator) with the virtual objects, in the real world, in real time. The onboard model can be full resolution or wire frame.

A data link can change and update the onboard model on real or near real time. Ground cameras can use the same system—without the need for stabilising/vibration removal—and GPS location may be sufficient (without inertial elements).

For example, in some embodiments television based images of the real world terrain of a course (either from another aircraft or on-board cameras) may be combined with virtual obstacles by considering the current position of the vehicle and calculating appropriate positions to apply the virtual obstacles. This spectator video creation process may also allow the appearance of shadows and perspective views of the competition course elements, which may change appropriately as the point of view of the video footage changes during the aircraft's navigation of the course. Furthermore, in internet enabled applications spectators may be given the option of choosing particular camera angles or views of the competition course which they would currently like to see. In further preferred embodiments the spectator video feeds may also integrate additional graphics or representations illustrating competitive separation or winning margins between vehicles.

In embodiments where penalties are employed to extend the length of the course for an infringing pilot, the above system for spectator video footage generation can clearly illustrate to a spectator the effect of penalties, and that the first vehicle crossing a finish line is the winner of a race. This approach allows course extension penalties to be applied automatically in real time, thereby making it obvious to a spectator the result of any competition.

In some embodiments the present invention may also facilitate a handicapped competition course layout methodology. In such embodiments aircraft (or other forms of vehicles) with different performance characteristics may compete head to head against one another at the same time over handicapped competition courses. For example, in such instances, a parallel course can be assigned to a slower aircraft which could be shorter, and potentially the magnitude of penalties applied to the slower aircraft could be reduced when compared to those applied to the faster aircraft. Those skilled in the art should appreciate that look-up tables of appropriate algorithms and formula may be employed to set course layout parameters for different aircrafts of varying performance, in addition to other environmental factors such as wind direction or weather conditions and so forth.

In some embodiments the present invention may also implement a collision avoidance system for pilots navigating the competition course. Such a collision avoidance system may warn pilots that a collision is imminent or highly likely. This facility of the present invention may monitor the trajectory and relative speeds of competing aircraft to provide graduated warning indicators depending on proximity and likelihood of collision. For example, in one embodiment, if two aircraft are determined to be heading towards one another the virtual obstacles displayed to each pilot may be replaced with emergency anti-collision arrows or direction indicators which assign a new heading to each pilot to avoid collision.

As mentioned, the present invention lends itself considerably to integration with not only airfield and online spectators, but also online or video game players. For example, it is envisaged that internet viewers and garners will be able to fly an equivalent virtual course using the ground computer data to match the skill against real life pilots in real time. These “virtual pilots” can elect to fly cooperatively or perhaps competitively. Further, the present invention readily allows the virtual pilots to send messages to each other, either chat or radio audio, or even interact with the real pilots in limited circumstances—say outside race times.

The virtual course, and its dynamic nature (including real time penalties and bonuses), is necessary for the real time execution of internet, video and computer gaming in real time. A ground computer system, which holds the virtual course, and the actual positions of all real competing aircraft/vehicles, can interact in real time with massive, multiple online, or onsite, competitors—piloting virtual vehicles/aircraft. Such a system can be used for all types of vehicle—or competitions involving skis, snowboards, bicycles, horses, unpowered aircraft etc.

Online gaming could occur in real time if the vehicle competition were real objects or obstacles, using similar positioning systems described in this patent specification, for example real vehicles will be competing through real obstacles but the positioning/ground computers can hold a map or model of the obstacle so it can present the virtual obstacles to virtual garners—in real time.

The online real time garners and competitors can have their experience enhanced through seeing real TV images of the race including composite images of real/virtual elements.

By recording the virtual races, the data can be employed to play back the races not only as perceived originally by the virtual pilots, but can include viewing from any angle online—as a consequence of the software associated with the present invention.

The recorded data can also be made available for repeated Competitions by online garners.

The filtering system mentioned previously can be used to limit the number of planes perceived as flying the virtual course at any one time.

The present invention may provide many potential advantages over the prior art.

The present invention allows for the deployment of a competition course where the route or routes available to navigate the course are at least partially defined by a set of virtual obstacles. The use of virtual obstacles to lay out a competition course, and in particular race courses, mitigates inherent risks associated with operating vehicles at high speed in close proximity to physical obstacles.

Furthermore, the use of virtual obstacles allows competition courses to be deployed faster than would normally be possible with real world physical obstacles. Such virtual obstacles may be displayed overlaid on a vehicle pilot's view of the competition course, and may also be applied to video footage of a competition for the benefit of spectators.

The present invention allows for the display of dynamic virtual objects which would be difficult if not impossible to implement with physical obstacles. Additional merchandising opportunities are available through the branding of obstacles.

The present invention can also automate the tracking of a vehicle's progress over the course and automatically assign penalties to a vehicle pilot if they do not successfully navigate the virtual obstacles displayed. In some instances these penalties may also be variable in extent or effect depending on the degree of infringement with a virtual obstacle.

The present invention may therefore allow for the implementation of a new and exciting form of vehicle competition which can combine racing skills with precision driving or piloting using penalties.

In the case of air racing applications pilots can elect to fly fast and less accurately, or slowly and more accurately—with each approach having a valid chance of winning the competition.

Furthermore, dynamic course changes can also be shown immediately to observers of the competition via the spectator video footage creation process discussed above.

Spectators can have a clear view of the same course elements that vehicle operators do, and also be able to clearly see that the vehicle which finishes the course first is the winner of the current competition.

The present invention also enables competition sports to be given an extra dimension by being available for virtual online spectators and competitors.

Physical objects require spectators to be physically close to the air race (in order to see the race) —whereas this technology allows a great degree of separation between the race and the spectators—using big outdoor screens. This is a noise and safety advantage.

### BRIEF DESCRIPTION OF DRAWINGS

Further aspects of the present invention will become apparent from the following description which is given by way of example only and with reference to the accompanying drawings in which:

FIG. 1 illustrates a block schematic flowchart of the steps executed by the present invention to calculate and assign a penalty to a vehicle pilot.

FIG. 2 illustrates a block schematic flowchart of elements and components employed to deploy a competition course in accordance with a further embodiment, and

FIG. 3 shows a block schematic diagram of the competition course deployed as experienced by a spectator, and

FIG. 4 illustrates a schematic showing the interaction between the various parts of the system in accordance with one embodiment of the present invention.

### BEST MODES FOR CARRYING OUT THE INVENTION

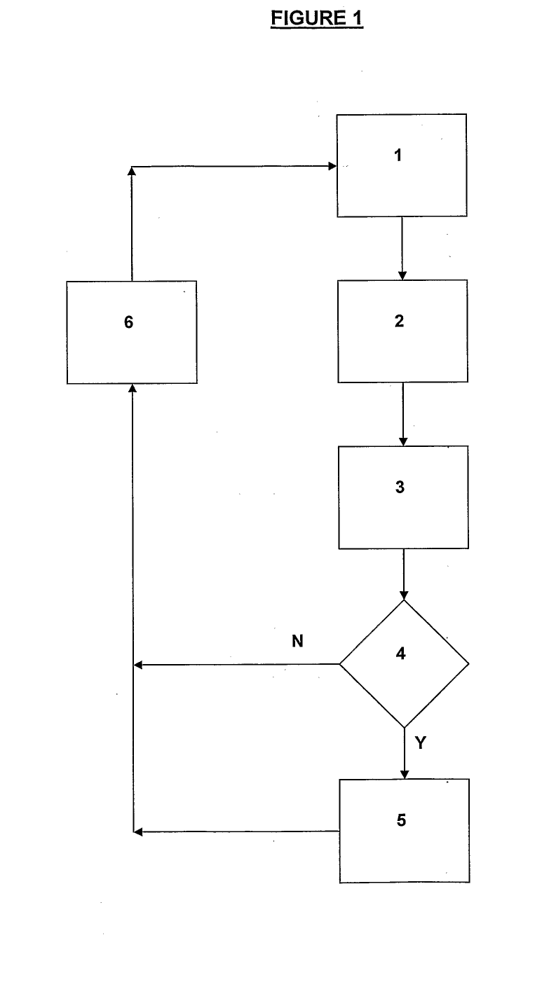

FIG. 1 illustrates a block schematic flowchart of the steps executed by the present invention to calculate and assign a penalty to a vehicle pilot.

The process illustrated with respect to FIG. 1 starts at stage (1) shown where a set of computer executable instructions initially receive a vehicle location identifier. In preferred embodiments this vehicle location identifier is provided by the current GPS/inertial co-ordinates of an aircraft navigating a competition course.

At stage (2) a comparison of the vehicle's GPS/inertial co-ordinates is made to identify any virtual obstacles which have associated locations within 100 metres of the current position of the vehicle.

At stage (3) the vehicle's GPS co-ordinates are used to prepare a volumetric model of the aircraft which in turn is compared with a collision region associated with each of the identified nearby collision regions.

At stage (4) of this process a determination is made as to whether a collision between the vehicle or aircraft and a virtual obstacle has occurred. This assessment is made through determining whether there is an intersection with a volumetric model of the aircraft and the defined collision region of a virtual obstacle.

If a collision is determined to have occurred, stage (5) of this process is executed to assign a penalty to the pilot of the vehicle. Stage (5) is completed by calculating the extent of the intersection between the obstacle's collision region and the model of the aircraft to determine a scaling factor multiplied against a baseline penalty value. In this embodiment of the invention the magnitude of a numeric penalty assigned to a pilot is minimised when the extent of overlap between an obstacle and the vehicle is minimised.

If no collision is deemed to have occurred, or after the assignment of penalties stage (6) of this process is executed. At stage (6) the computer executable instructions provided instigate a wait or delay process of half a second prior to looping back to execute the process again from stage (1) onwards.

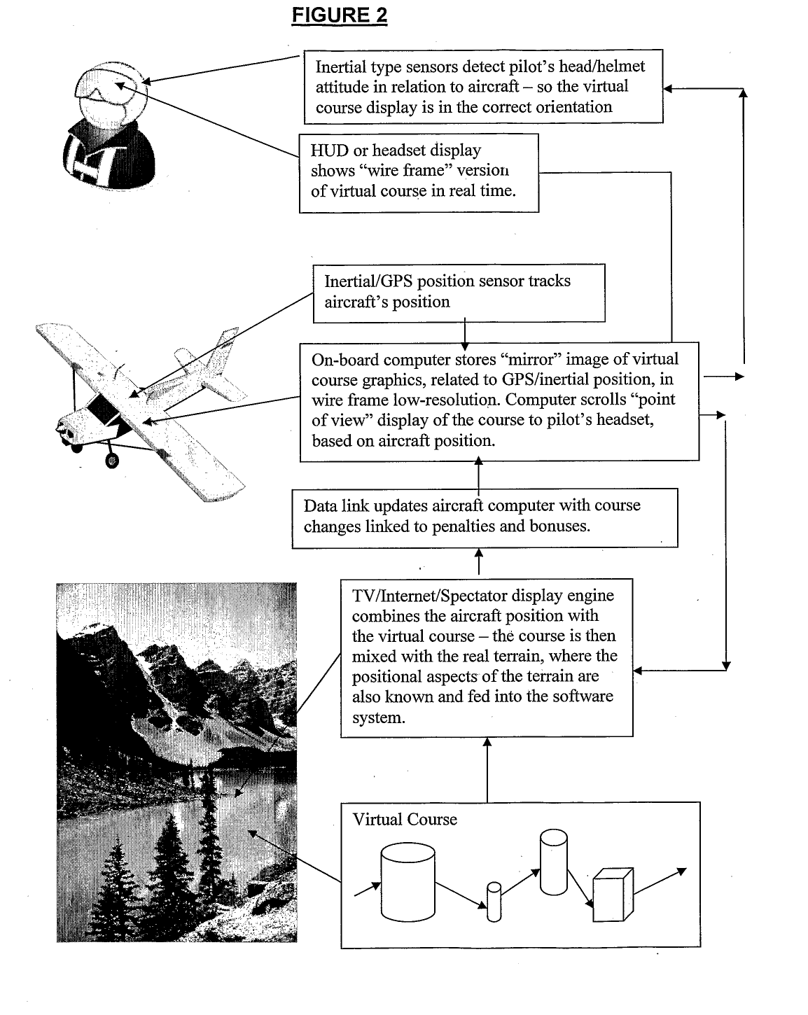

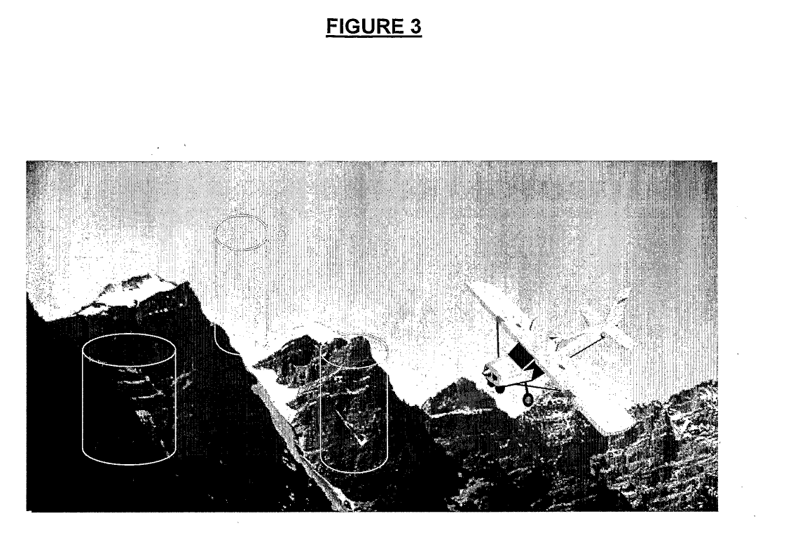

FIG. 2 illustrates a block schematic flowchart of elements and components employed to deploy a competition course in accordance with a further embodiment. FIG. 3 shows a block schematic diagram of the competition course deployed as experienced by a spectator.

As can be seen from FIG. 2 elements and components of the present invention in one embodiment are illustrated. A HUD or head set display can show a wire frame version of the virtual course in real time overlaid on a pilot's view. This HUD display also includes inertial sensors to detect the pilot's head orientation.

The vehicle employed in this embodiment is an aircraft which incorporates inertial and/or GPS position determination systems in combination with an on-board computer.

A remote processing base station is used to receive position data from the aircraft and to generate spectator video footage. This footage combines a virtual course composed of virtual obstacles assigned locations in an area of real terrain over a view of this terrain. The spectator footage generated is similar to that shown with respect to FIG. 3.

The remote processing station has access to data transfer connections to upload data to an aircraft's local model of the competition. Uploads can be provided for any changes made to the course structure based on penalties and bonuses applied to aircraft pilots. The local on-board computer of the aircraft utilizes the vehicle's position information in combination with any updates to the competition course to display a wire frame version of the virtual course to a pilot in real time.

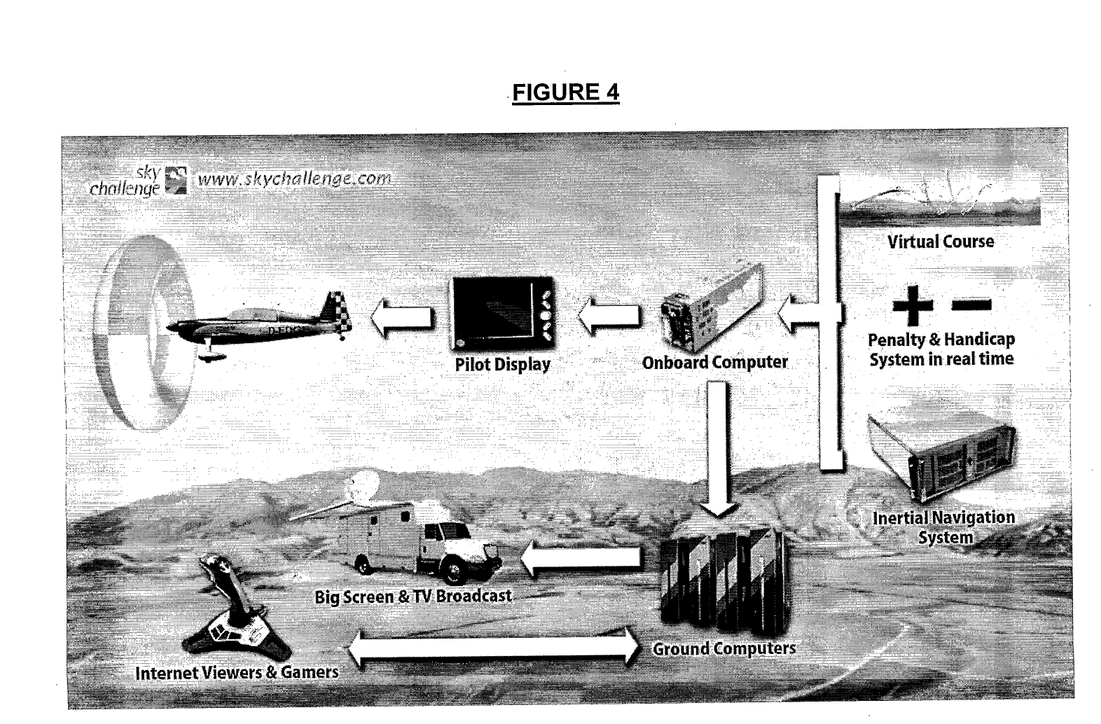

FIG. 4 is a more pictorial representation of the interactions with various components and the implementation of the present invention.

As should be apparent, it is essential for the present invention to know the precise position of the vehicle/person/aircraft (entity) as well as knowing the precise orientation of the vehicle/person/aircraft (entity) to determine if it has partially or wholly entered the conflict zone of a virtual object. A 3D digital model of the entity is used to determine the space, occupied by the entity—so this can be constantly compared to the space occupied by the virtual object. In the case of the aircraft—the values are position (x, y and z axis plus attitude—pitch, roll and yaw—i.e. at least six degrees of freedom) linked to a digital model of the aircraft and the volume it occupies.

A preferred methodology for setting up and running a race in accordance with the present invention is given below. It will be obvious that certain, simple technical changes can be made for other types of race. It will also be obvious that the same system could be used to train, instruct and assess people in navigation, driving, sailing and pilot skills.

A positional platform (PP), consisting of key components is installed in the aircraft—along with an onboard computer (OC) and the associated power supplies (from batteries and the plane's own power supply).

Also onboard are components to do with data transmission/processing (bidirectional data, modems, error checking software, remote switching of onboard cameras/video sources and the provision of video/audio signals for TV coverage) —the transmission package (TP).

The TP uses microwave and/or VHF/UHF frequencies—as well as multiple (180 degree opposed) aerials (internal and external) and multiple frequencies so that regardless of the attitude of the aircraft a continuous stream of data is received on the ground. Diversity software systems on the ground constantly compares signal quality/strength from the different aerials/frequencies—and selects the best quality signal. Error checking software also is embedded into the signals to correct small transmission errors. A display unit or headset is also installed (Display) which shows the output from the Onboard Computer to the pilot.

The components in the positional platform are: an Inertial Measurement Unit (IMU) (capable of performance at up to 15 G positive/negative), GPS unit, differential GPS receiver/processor and a small computer which constantly measures the positional solution from each unit—and uses advanced mathematics to compute the best consolidated solution.

The Kalman filter algorithm is used—as well as some custom written code.

The IMU needs to be of a very high (military) specification to produce data at a fast enough rate to satisfy the requirements of this application—in test flights we used a Honeywell HG 1700 (x2) 50 G unit from the US Advanced Medium Range Air to Air Missile (AMRAAM) —after rejecting lower specification IMU's as not working successfully in the highly dynamic environment of an aerobatic air race. The solution produced by the PP is precise position and precise attitude.

The PP (GPS, differential GPS and inertial measurement units) can produce the required frequency and quality of data—as long as the components are properly calibrated and filtered. The data rate also needs to be rapid enough to meet the requirements of television (26 frames per second) and the human eye (16 cycles per second). The true sample rate in fact needs to be close to 50 per second (and higher) in order to allow for error sampling software to be used in the data link to the ground, as well as the constant solution comparisons to correct drift in the IMU and GPS solutions. The custom software gives priority to the solution in which we have most confidence under different circumstances (e.g. loss of GPS satellite signal, priority is given to IMU, lack of dynamic input to the IMU—GPS has priority).

The OC is a small, powerful computer, using ARM processors, which receives positional and attitude data from the PP and produces a display output showing the stored virtual course/objects relative to the current aircraft position. The OC also generates an artificial horizon for the display—and runs an arrow/prompt system (see below) to help the pilot navigate to the objects. Penalty and object collision/conflict algorithms are also stored in the OC (see below). The OC compares the stored virtual objects which make up the course with the stored digital model of the aircraft—and constantly measures whether the volume of the aircraft infringes any part of the virtual objects. This measurement is precise enough to be incremental—in other words the OC can measure whether a plane's wing has just touched a virtual object (say by 1 metre or less)—or whether the entire wing structure and fuselage which make up the aircraft have “hit” the main mass of the virtual object.

Prior to a race, a course is designed by a specialist test pilot who understands the capabilities of the both the pilot and the aircraft. The course is then turned into a left and right hand version—so that the competing aircraft are always turning away from each other—rather than towards each other. The courses are designated Left and Right—and certain, comprehensive safety procedures are put in place to ensure that the correct course is loaded into the appropriate aircraft. The pilot of the aircraft is also informed of the course which is loaded—and there is an external indication in the cockpit as to which course is loaded. A ground marshal confirms that the correct courses are loaded into the correct aircraft—and the cockpit course indication is clear and correct.

After the course layout has been determined, the virtual objects are designed and determined. In test flights the objects typically had an outside diameter of 40 metres and an inside diameter of 25 metres. The dimensions were determined relative to the wingspan and length of the aircraft (approximately 15 metres and 17 metres) so that the objects were difficult, but not impossible, for pilots to negotiate. Each object is loaded into a real world matrix/model—which is a cube 20 kilometres on each axis. This 20 kilometre cube defines the limits of the digital model stored inside the OC, and the PP. The virtual objects are each “anchored” to real world coordinates on three axiis. The shape of virtual objects can vary from a “doughnut” shape, to diamond shapes, 3D tunnels and even revolving, animated 3D corporate logos.

A handicapping system allows the initial course for each pilot to be, tailored to certain parameters which result in course changes. Changes can be to individual course length, object size/difficulty, penalty increments and other advantages/disadvantages. Triggers for handicapping can include aircraft power (a shorter course for a less powerful aircraft), pilot skill, and penalties from previous races. The handicapping system allows for “fair” races between aircraft of different power/performance and pilots of different skill/experience.

A high resolution digital 3D photorealistic terrain model is built on a ground computer (GC) and a visual 3D model is built of each aircraft (with exact physical dimensions and photo realistic markings etc). The model of the (20 km cube) world is built from satellite photography, topographical maps, digital maps and other sources. The digital plane models are built from blueprints, CAD models and detailed photographs.

The course is loaded into both the OC and GC—the GC holds a combined course, but the OC in each plane only receives a left or right hand single course. The penalty and object conflict algorithms are the same in both the GC and OC's. The GC virtual objects include texture, colour and shadows, whereas the same objects in the OC are simpler, wireframe versions.

Object conflict algorithms determine the degree of conflict between the volume of the virtual object and the volume of the 3D aircraft digital model. For the purposes of illustration, three degrees (or more) of penalty can be deduced from a conflict. A conflict of say 0-2 metres can produce 1 increment of penalty, a conflict of 2-7 metres (or say 35% of the mass/volume of the aircraft) can produce two increments of penalty, and a conflict of 8-15 metres (up to 100% of the aircraft volume) can produce 3 increments of penalty. A penalty increment, in its most simple form, would have the result of moving the finish line for that pilot 100 metres away from the original position—in other words that course becomes 100 metres longer. Three increments would equal 300 metres of extra course length.

Conflict algorithms can also be used for a “bonus box” —which would be positioned as a detour to the main course, but would have the opposite effect to the above penalties. Conflict with a bonus box would make the course 100 metres shorter for each increment of conflict.

The conflict measurements from the OC are also replicated on the ground by the GC—and the two systems can agree a result by a simple comparison of data via the TP. The OC also displays to the pilot the increments of penalty incurred—and the finish line for that pilot is moved in the digital model (20 km cube) by the appropriate distance. The same operation is performed by the GC. In another method, if the degree of agreement between the two computers is not exact, then the OC can send a simple data packet to the GC indicating the penalty increments. Because the increments are fixed and precise (1 increment equals 100 metres) very small amounts of data are needed to update the course model in the GC. The GC can send a signal to the non-conflicting aircraft —(the other pilot) so that it is clear that he is at an advantage to the infringing pilot. This operation can obviously work in reverse—so that both pilots are constantly aware of the level of penalty being carried by each other as the race progresses.

Calibration flights need to be run to ensure that the position of the aircraft is exactly the same in the OC and GC digital models. The data link from the aircraft TP tells the GC where to position the aircraft in the digital world model—and also dictates the orientation of the aircraft. Software on the GC allows a virtual camera or cameras to “fly” through the virtual world—relative to—the real time positions of the racing aircraft. The GC animation feature also allows TV coverage using 100% virtual imagery—and the insertion of real time vectors and graphic features showing the distance between competing aircraft, forecast winning/losing margins, number of penalties, speed flown, time to finish and other interesting features derived from the real time data.

The pilot display shows a virtual horizon or artificial horizon—derived from the OC and PP. The virtual objects are displayed as wireframe images (to reduce processing power in the OC and to give a better sense of 3D perspective on a small display) over the horizon display. A 3D arrow prompt generated by the OC also gives the pilot indications as to the distance and direction of the next virtual objects. This arrow/prompt is very important in assisting the pilot to judge distance and direction relative to the objects (and subsequent objects beyond the “immediate” or closest object).

The OC can also output to a headset display, which can be monocular or stereoscopic. The headset display can also be linked to a head orientation system—so that the OC displays the horizon, arrow prompt and objects relative to the pilot's head position. The pilots head position can be calculated using infrared reflective dots on the back of the helmet—and two infrared/transmitter sensors fixed to the back of the seat—other methods, including small IMU's can also be used. The OC calculates an offset between aircraft position/attitude (from the PP) and the pilots position and head orientation. This results in the pilot being able to see the virtual objects in their “true” position regardless of where he is looking. This means that virtual objects could be viewed through the floor and side of the aircraft. If this was uncomfortable for the pilot, the OC display could include a mask that would either make the objects invisible through the aircraft fuselage—or render them at a video percentage of “full visibility”—e.g. 20% when viewed through the fuselage.

Prior to a race each aircraft needs to perform some dynamic manoeuvres in the air (“S” turns work well) to give the PP a chance to orientate and calibrate itself to the real world. The PP also needs to be powered up on the ground for some minutes prior to take off—so that the various components can establish good “agreement” on position solution and software communication between the components.

For television and interactive internet coverage of a race—certain other systems need to be in place.

Cameras on the ground need to be calibrated so that the virtual objects from the GC course can be superimposed over the “real world” images from the camera. Masking layers also need to be introduced into the television systems. Calibration of the ground cameras involves determining their exact GPS position—and then using markers of a known height and distance from the camera to adjust the camera shots to match the “correct” size and perspective of the virtual objects in the sky.

The objects are then “layered” so that from the camera's perspective a race plane passes “behind” the “front” section of the virtual object—but in front of the “rear” sections of each object. This layering happens in TV software (chroma or luminance keying—or other methods)—and each layer model is assigned to a particular camera and virtual object. A computer is dedicated to each of these object/camera pairs—as the processing of each TV frame has to happen in real time—rendering the object “around” the real world plane—and even relative to display smoke from the real plane. Only a dedicated computer has the power to “re-draw” these complex frames in real time—combining a fast moving real plane with static real world background and static or rotating virtual objects.

For TV broadcast purpose, an auxiliary Outside Broadcast truck would be used so that only “complete” composite camera/object pairs were available to the main Outside Broadcast truck. “Incomplete” camera shots would be of no use to the TV broadcast as the objects would be missing, or the real aircraft would not interact with the virtual objects in the correct “layered” order.

It is possible for computer software to determine the exact state of the camera lens (focal plane, pan, tilt and zoom) as well as the position of the focal plane. This method will allow a ground based or airborne stabilised helicopter camera to cover a virtual air race—and pan, tilt and zoom relative to the real planes, real world and virtual objects. In the simplest example, the virtual object will get bigger as the camera lens zooms in to that object.

In a race, each aircraft will position itself at a pre-determined “pre-start” position—and confirm by radio that they are ready to start. The PP on each plane will be displaying the course to each pilot via the OC and the display. The TP will be sending data to the ground which includes aircraft position, attitude and output from various onboard cameras and microphones. There is a small delay in the processing of this data so that the ground data may be up to half a second “late” relative to the onboard data. The time lag can be addressed by introducing matching delay to the output from other video sources such as ground cameras.

Once the pilots have confirmed they are ready—and their displays are working correctly—a system countdown is initiated. Typically this would involve a software signal which causes a physical countdown to start at the first race obstacle—in the form of numbers displayed in the centre of the object—counting down from 10 to 0. The system countdown is replicated between the two OC's and the GC. Synchronisation signals keep the three systems coordinated. In the simplest version of the race—agreement between the various computers is not necessary as the virtual objects are anchored to the “real world” and the planes are flying relative to the “real world.

In the case of a live video game—an internet community would all be connected to the GC—via suitable internet protocol interfaces. Internet players would see the same live positional data—in the form of digital aircraft overlaid on the digital terrain model.

The video game computer systems would allow unlimited numbers of remote players to log onto an extension of the GC—which can either be on the airfield or at a remote data centre. The internet gaming computer (IGC) is simply a mirror of the GC—except that it allows massive interaction with the “base model” of fixed world (20 km cube), virtual objects and two real aircraft. A complex filtering system would configure the degree to which online players using the IGC would be able to “see” each other. Filter values can include: position in an online performance league, country of residence, position in the race relative to the real pilots, relationship to other online pilots (friends can see friends) or other user defined groups. IGC's could easily be mirrored or replicated across a number of different data centres in different geographical locations around the world. IGC's could also easily store past races so that online garners can replay the same race on a number of occasions.

In the most simple video game illustration—and laptop computer receives the real time position of a single competing aircraft on the right hand course—and the virtual or computer pilot flies a virtual plane on the left hand course. In this simple illustration the two courses are of the same length, the real and virtual plane have the same flight characteristics, and the penalty increments are the same. It is easy to see how simple changes to this combination (course length/handicap, penalty increments, flight characteristics of the virtual plane) can change the nature of the real vs. virtual pilot race. The IGC network can handle these different attributes for a massive number of online competitors.

The race is over when all aircraft have crossed the finish line. Because of the real time penalty system the first aircraft to cross the finish line is the winner, with no need for post-race penalties or judges to assess appeals or complaints about race conduct. Neither the real or virtual planes can interfere with each other's performance.

As discussed previously, a collision avoidance system ensures that if any two aircraft are on a collision course that the display immediately changes to the arrow/prompt showing an escape trajectory. The GC calculates whether aircraft are on a conflicting path. A conflicting path is only possible if the aircraft stray off their respective courses. In the case of computer failure, the pilots are under standing instructions to break away from their course—i.e. the left hand pilot breaks left and the right hand pilot breaks to the right.

Aspects of the present invention have been described by way of example only and it should be appreciated that modifications and additions may be made thereto without departing from the scope thereof as defined in the appended claims.

What we claim is:

1. A set of computer executable instructions configured to calculate penalties for a vehicle pilot navigating a competition course which incorporates at least one virtual obstacle, said set of instructions being configured to execute the steps of:
a) receiving a vehicle location identifier associated with the present position of the pilots vehicle, and
b) comparing the vehicle location identifier with a collision region associated with at least one virtual obstacle of the competition course, and
c) assigning at least one penalty to the pilot of the vehicle if the vehicle's location intercepts with the collision region of an obstacle, and
d) repeating steps a) through c) as the pilot navigates the competition course and the position of the vehicle changes.

2. A set of computer executable instructions as claimed in claim 1 wherein the vehicle is an aircraft.

3. A set of computer executable instructions as claimed in either claim 1 or claim 2 wherein the location identifier is provided by a set of GPS coordinates.

4. A set of computer executable instructions as claimed in claim 3 wherein the location identifier is calculated using data from inertial sensors.

5. A set of computer executable instructions as claimed in any one of claims 1 to 4 wherein the virtual objects have a dynamic nature.

6. A set of computer executable instructions as claimed in any one of claims 1 to 5 wherein a penalty assigned to a pilot has the effect of extending the length of the competition course to be navigated by the pilot.

7. A set of computer executable instructions as claimed in any one of claims 1 to 5 wherein a penalty assigned to a pilot has the effect of shortening the length of the competition course to be navigated by the pilot.

8. A set of computer executable instructions as claimed in any one of claims 1 to 7 wherein the effect of a penalty increases with the extent of a collision between a vehicle and a virtual obstacle.

9. A set of computer executable instructions as claimed in any one of claims 1 to 8 wherein virtual obstacles are displayed to a pilot of a vehicle using a heads up display or headset or panel mounted display.

10. A set of computer executable instructions as claimed in claim 9 wherein the orientation of the pilot's head is factored into the display.

11. A set of computer executable instructions as claimed in claim 10 wherein the orientation of the pilot's head is determined by reflectors on the pilots helmet sensed by sensors within the vehicle.

12. A set of computer executable instructions as claimed in any one of claims 9 to 11 wherein the virtual course is displayed in colour.

13. A set of computer executable instructions as claimed in any one of claims 9 to 11 wherein the information is displayed to the pilot in addition to the virtual obstacles.

14. A set of computer executable instructions as claimed in any one of claims 9 to 13 wherein the display to the pilot can be removed.

15. A set of computer executable instructions as claimed in any one of claims 1 to 14 wherein real and virtual images are combined in real time utilising camera parameters.

16. A competition display system utilizing a set of computer executable instructions as claimed in any one of claims 1 to 15.

17. A method of calculating penalties for a vehicle pilot navigating a competition course which includes at least one virtual obstacle, said penalties being calculated by the execution of the steps of;
a) receiving a vehicle location identifier associated with the present position of the pilot's vehicle, and
b) comparing the vehicle location identifier with a collision region associated with at least one virtual obstacle of the competition course, and
c) assigning at least one penalty to the pilot of the vehicle if the vehicle's location intersects with a collision region of an obstacle,
d) repeating steps a) through c) as the pilot navigates the competition course and the position of the vehicle changes.

18. Hardware configured to operate in accordance with the set of computer executable instructions as claimed in any one of claims 1 to 15

19. Hardware configured to provide a vehicle location identifier for use in the computer executable instructions as claimed in any one of claims 1 to 15, wherein the hardware includes GPS, inertial systems and at least one processor.

20. A video game configured to display and interact with the competition display system as claimed in claim 16.

21. A video game as claimed in claim 20 configured to enable users to pilot a virtual vehicle on a virtual course at the same time as a real pilot flying the virtual course.

22. A set of computer executable instructions substantially as herein described with reference to the accompanying drawings.

23. A method substantially as herein described with reference to the accompanying drawings.

24. A competition display system substantially as herein described with reference to the accompanying drawings.

25. Hardware configured substantially as herein described with reference to the accompanying drawings.

26. A video game substantially as herein described with reference to the accompanying drawings.
